(19) United States
(12) Patent Application Publication
(10) Pub. No.: US 2015/0100508 A1
(43) Pub. Date: Apr. 9, 2015

(54) SYSTEMS AND METHODS TO ASSESS THE CONDITION OF A PROPERTY

(71) Applicant: STATE FARM MUTUAL AUTOMOBILE INSURANCE COMPANY, Bloomington, IL (US)

(72) Inventors: Todd Binion, Bloomington, IL (US); Kelly S. Minter, Normal, IL (US); Heidi Brown-McCreery, Bloomington, IL (US); Michael Harris, Normal, IL (US); Jeremy Myers, Normal, IL (US); Brian Fields, Normal, IL (US); Joe Harr, Bloomington, IL (US)

(73) Assignee: STATE FARM MUTUAL AUTOMOBILE INSURANCE COMPANY, Bloomington, IL (US)

(21) Appl. No.: 14/047,279

(22) Filed: Oct. 7, 2013

(51) Int. Cl. G06Q 50/16; G06Q 10/06

(52) U.S. Cl. CPC G06Q 50/16; G06Q 10/06
USPC 705/313

(57) ABSTRACT

A method for reporting property ownership information includes receiving an enrollment from a customer and retrieving existing condition data corresponding to the property from a condition database. Further, the method includes gathering additional condition data corresponding to the property and analyzing the existing condition data and the additional condition data to establish a property condition trend. Subsequently, a property ownership report is generated and communicated to a remote computing device for presentation to a customer.

### TECHNICAL FIELD

The present disclosure generally relates to assessing the condition and/or value of a property, such as a house, and, more particularly, to a method for gathering and analyzing condition related data.

### BACKGROUND

Often property owners are unable to accurately assess the current condition or value of a property, such as a house, commercial building, etc., because the only available information about the property is maintenance/repair records or current tax assessments. It is impossible to accurately assess the condition of a property from such general information, and, as a result, property owners are often faced with unexpected repair costs, abnormal utility behavior, and/or unnecessary property depreciation.

Moreover, property buyers are often unaware of relevant information regarding the past condition of a property for sale. Prior to acquiring the property, a buyer might not know how functional components of the property operate (e.g., utility usage or costs, energy consumption), how individual appliances influence costs (e.g., kitchen, heating, etc. appliance contributions to monthly energy), and when certain components of the property will need to be replaced (e.g., furnace, water heater, refrigerator, garage door opener, etc.).

### SUMMARY

In one embodiment, a computer-implemented method for reporting property ownership information comprises receiving, via a computer network, an enrollment from a customer, wherein the enrollment includes information identifying a property, retrieving existing condition data corresponding to the property from a condition database, wherein a device inside the property generates at least some of the existing condition data while components of the property are being operated, and gathering, via the computer network, additional condition data corresponding to the property, wherein at least some of the additional condition data is generated at a time after the generation of the existing condition data. Further, the method comprises analyzing, with one or more processors, the existing condition data and the additional condition data to establish a property condition trend, wherein the property condition trend reflects changes in a condition of the property, wherein the condition of the property relates to at least one of a quality or a value of the property, generating, with one or more processors, a property ownership report, wherein the property ownership report includes indications of the property condition trend, and communicating, via the computer network, the property ownership report to a remote computing device for presentation to the customer.

In another embodiment, a computer-implemented method for reporting property condition information on a computing device including a display device and a user interface comprises: receiving, via the user interface, a property enrollment, wherein the enrollment includes information identifying a property, generating, with one or more processors, a property condition query, wherein the property condition query includes the information identifying the property, and sending, via a network interface at the computing device, the property condition query to a server. Further, the method comprises receiving, via the network interface at the computing device, information indicative of a property condition trend, wherein the property condition trend reflects changes in a condition of the property, wherein the condition of the property relates to at least one of a quality or a value of the property, and wherein the condition of the property is based on an analysis of condition data generated by devices inside the property while components of the property are being operated. Still further, the method comprises rendering, with one or more processors, an image of at least some of the information indicative of the property condition trend, and presenting, via the display device, the image of at least some of the information indicative of the property condition trend.

In yet another embodiment, a computer device for reporting property ownership information comprises one or more processors, and one or more non-transitory memories coupled to the one or more processors, wherein the one or more memories include computer executable instructions stored therein that, when executed by the one or more processors, cause the one or more processors to: receive, via a computer network, an enrollment from a customer, wherein the enrollment includes information identifying a property and retrieve existing condition data corresponding to the property from a condition database, wherein a device inside the property generates at least some of the existing condition data while components of the property are being operated. Further, the computer executable instructions cause the one or more processors to gather, via the computer network, additional condition data corresponding to the property, wherein at least some of the additional condition data is generated at a time after the generation of the existing condition data and analyze the existing condition data and the additional condition data to establish a property condition trend, wherein the property condition trend reflects changes in a condition of the property and wherein the condition of the property relates to at least one of a quality or a value of the property. Still further, the computer executable instructions cause the one or more processors to generate a property ownership report, wherein the property ownership report includes indications of the property condition trend and communicate, via the computer network, the property ownership report to a remote computing device for presentation to the customer.

### BRIEF DESCRIPTION OF THE DRAWINGS

FIG. 1 illustrates an example system in which a condition report server may assess the condition of a property.

FIG. 2 illustrates an example server that can be implemented as the condition report server illustrated in FIG. 1.

FIG. 3 illustrates an example end user device that can be implemented as one of the end user devices illustrated in FIG. 1.

FIG. 4 is a flow diagram of an example method for developing property condition trends which can be implemented in the system illustrated in FIG. 1.

FIG. 5 is a flow diagram of an example method for reporting property condition information which can be implemented in the system illustrated in FIG. 1.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such terms should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

As used herein, the term “property” may refer to any of a number of parcels of land and the buildings or housing thereon. A property may be a single-family home, attached/multi-unit dwelling, semi-detached dwelling, portable dwelling, apartment building, duplex, townhouse, commercial real estate, office building, industrial building or infrastructure, hotel/motel, farm/ranch, etc.

### System Overview

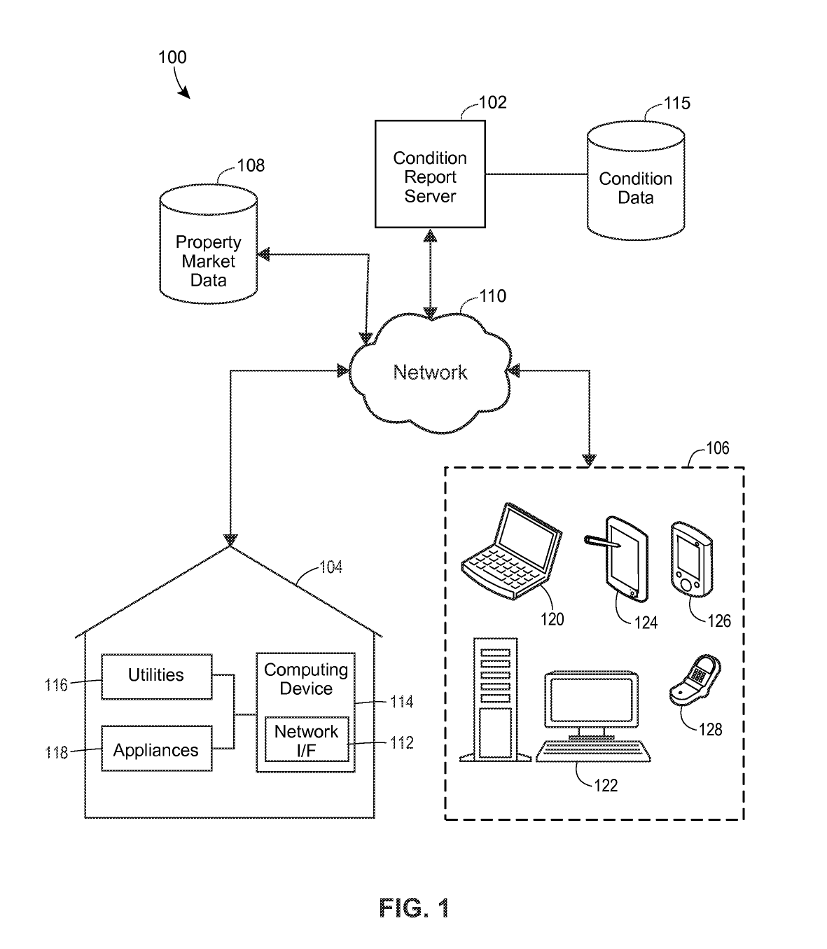

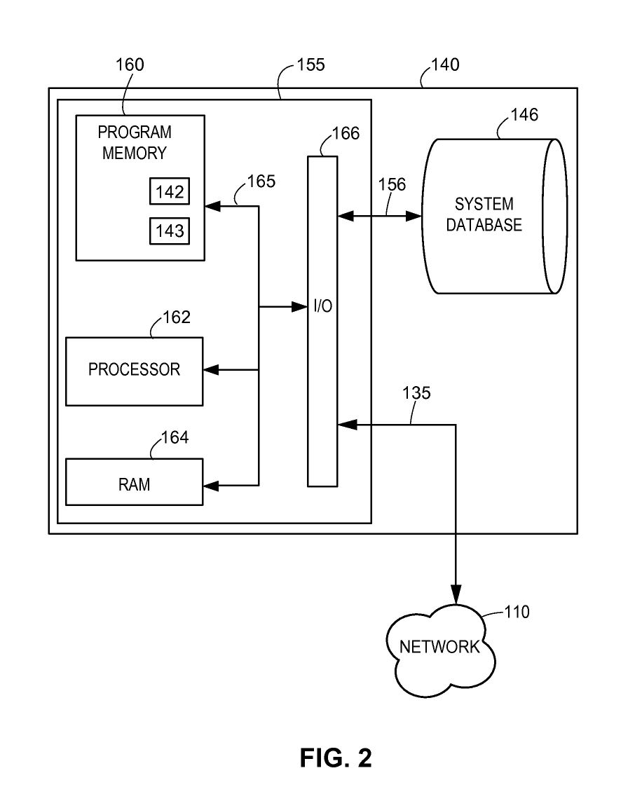

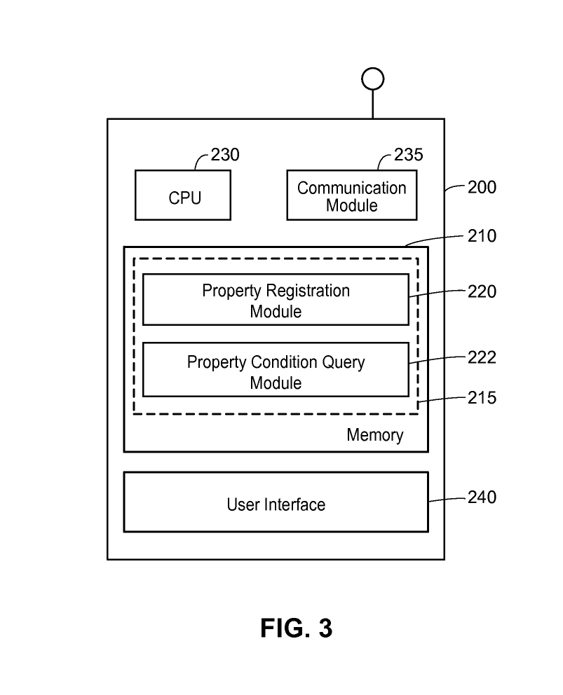

FIG. 1 illustrates an example system 100 in which the condition of a property 104 can be accurately assessed and reported to an owner of the property or other interested party. A condition report server 102 and one or more end user devices 106 are communicatively coupled to a network 110. Additionally, the property 104 is communicatively coupled to the network 110 via a network interface 112 of a computing device 114 (e.g., a desktop/laptop computer, tablet computer, home automation device, etc.). The network 110 may be a proprietary network, a secure public internet, a virtual private network or some other type of network, such as dedicated access lines, plain ordinary telephone lines, satellite links, combinations of these, etc. Where the network 110 comprises the Internet, data communications may take place over the network 110 via an Internet communication protocol. Further details of an example condition report server and an example end user device are described with reference to FIG. 2 and FIG. 3, respectively.

In some implementations, the computing device 114 may upload condition data to the condition report server 102 via the network 110. For example, the computing device 114 disposed in the property 104 may wirelessly upload data from one or more utilities 116 (e.g., water pipes, gas lines, etc.) and one or more appliances 118 (e.g., furnaces, refrigerators, washers, etc.), via the network interface 112 for assessing the condition of the property 104. In turn, the condition report server 102 may store the condition data in a condition database 115 that is communicatively coupled to the condition report server 102. The condition database 115 may include an assortment of computer-readable media. By way of example and without limitation, computer-readable media may include both volatile and nonvolatile media, removable and non-removable media. In some implementations, the condition database 115 may include existing condition data 130 from previous property owners and additional condition data 131 from the current property owner.

Although the example system 100 is shown to include one condition report server 102 and five end user devices 106, it is understood that different numbers of servers and end user devices may be utilized. Furthermore, the processing performed by the condition report server 102 may be distributed among a plurality of servers in an arrangement known as “cloud computing,” in an implementation. This configuration may provide several advantages, such as enabling near real-time uploads and downloads of information as well as periodic uploads and downloads of information, for example.

In some implementations, the computing device 114 may control or be integrated with a home security, automation, or temperature control system. For example, the computing device 114 may be communicatively connected (e.g., via a Wi-Fi connection) to a “smart” thermostat that is accessible via a web browser or dedicated application executed on any of the end user devices 106. In another example, the computing device 114 may be part of a home automation system configured to allow a property owner to open doors, adjust a thermostat, turn on/off lights, etc. from a location other than the location of the property 104. In general, however, the computing device 114 may be any suitable computing device configured to gather data from the utilities 116 and the appliances 118 and send the gathered data to the condition report server 102.

In addition to the condition database 115, the condition report server 102 and some or all of the end user devices 106 may communicate with a property market database 132, in an implementation. The property market database 132 may, for example, store information about properties for sale, properties for rent, properties not currently on the market, properties purchase prices, property offer prices, tax assessments, public record data, time series data (e.g., listing prices, tax assessments, etc. over time), estimated mortgage payments, etc. Although FIG. 1 illustrates the property market database 132 as one database, such public information about properties may be stored on any number of suitable databases accessible by any numbers of networks and/or servers. Further, in some implementations, the property market database 132 may include data accessible only to certain groups or individuals, such as real estate agents, insurance agents, etc.

FIG. 2 illustrates an example server 140 that may be implemented as a condition report server, such as the condition report server 102. The example server 140 includes a controller 155 that is operatively connected to the database 146 via a link 156, and it should be noted that, while not shown, additional databases may be linked to the controller 155 in a known manner. The controller 155 may include a program memory 160, a processor 162 (may be called a microcontroller or a microprocessor), a random-access memory (RAM) 164, and an input/output (I/O) circuit 166, all of which may be interconnected via an address/data bus 165. The program memory 160 may be configured to store computer-readable instructions that when executed by the processor 162 cause the server 140 to implement a server application 142 and a web server 143. The instructions for the server application 142 may cause the server 140 to implement the methods described herein.

While shown as a single block in FIG. 2, it will be appreciated that the server application 142 may include a number of different programs, modules, routines, and sub-routines that may collectively cause the server 140 to implement the server application 142. It should be appreciated that although only one microprocessor 162 is shown, the controller 155 may include multiple microprocessors 162. Similarly, the memory of the controller 155 may include multiple RAMs 164 and multiple program memories 160. Further, while the instructions for the server application 142 and web server 143 are shown being stored in the program memory 160, the instructions may additionally or alternatively be stored in the database 146 and/or RAM 164. Although the I/O circuit 166 is shown as a single block, it should be appreciated that the I/O circuit 166 may include a number of different types of I/O circuits. The RAM(s) 164 and program memories 160 may be implemented as semiconductor memories, magnetically readable memories, and/or optically readable memories, for example. The controller 155 may also be operatively connected to the network 130 via a link 135.

FIG. 3 illustrates an example end user device 200 capable of reporting property condition information to a customer, as discussed below. The end user device 200 may be implemented as one of the end user devices 106, for example. The end user device 200 includes a computer readable memory 210 in the form of volatile and/or nonvolatile memory such as read only memory (ROM) and random access memory (RAM). The memory 210 may store a property ownership tool 215 including a property enrollment module 220 and a property condition reporting module 222 to be executed by a CPU 230. In one implementation, the property ownership tool 215 may be available at an online application store disposed at an application server (not shown), for example. A user may retrieve a copy of the property ownership tool 215 from the server and “install” the retrieved copy of the property ownership tool 215 on the end user device 200.

In other implementations, the end user device 200 is capable of executing a graphical interface (GUI) for an online property ownership tool within a web browser application, such as Apple's Safari®, Google Android™ mobile web browser, Microsoft Internet Explorer®, etc. The web browser application may be implemented as a series of machine-readable instructions for receiving, interpreting, and displaying web page information (e.g. from web server 143) while also receiving inputs from the user.

Further, the portable device 200 also includes a communication module 235, that facilitates wireless communication for data exchange over a mobile and/or wide area network, and a user interface 240. The user interface may include devices to receive inputs from a user, such as a keyboard, touchscreen, buttons, trackballs, etc., and display devices, such as liquid crystal displays (LCD), light emitting diodes (LED), organic light-emitting diodes (OLED), ePaper displays, etc.

### Property Condition Assessment

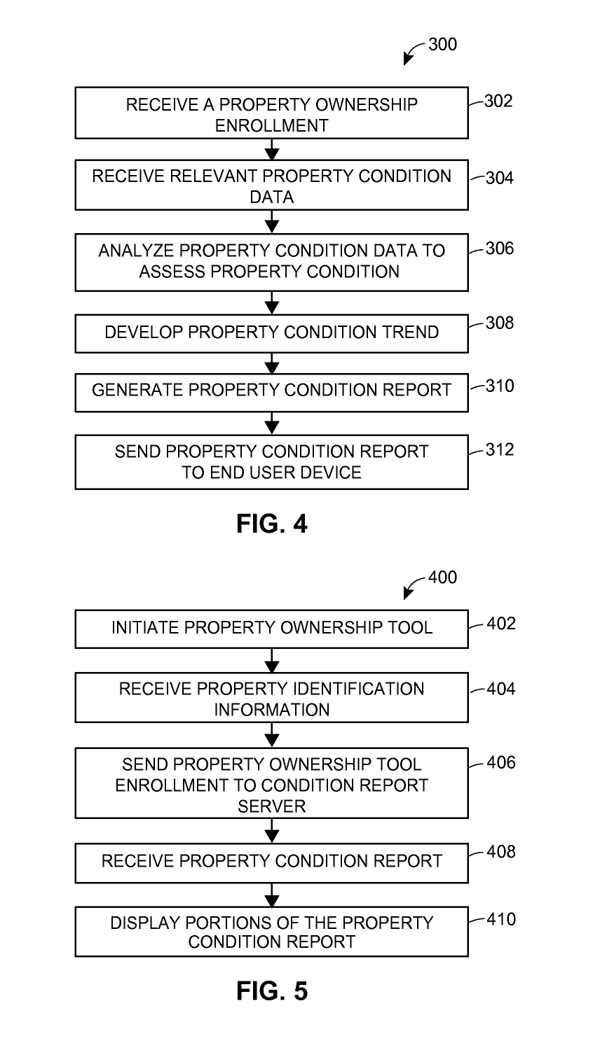

FIG. 4 is a flow diagram of an example method 300 for assessing the condition or value of a property based on property condition data. The method 300 may be implemented in the condition report server 102, for example.

To begin, a property enrollment is received from an end user device (block 302). In one scenario, an owner of a property may use one of the end user devices 106 to enroll a property for property condition reporting, as described below, by entering information identifying the property, via a user interface. For example, the information identifying the property may include an address, property nickname (e.g., home, rental on Sunset Ave., etc.), owner name, phone number, zip code, homeowner's insurance policy number, year of construction, etc. In turn, the one of the end user devices 106 may send an enrollment, including the information identifying the property, to the condition report server 102 to obtain an assessment of the past, current, and/or future condition (e.g. quality or market value) of the property, in the example scenario.

Upon receiving the property enrollment, condition data, corresponding to the property identified in the property enrollment, is retrieved from a property condition database (block 304), such as condition database 115. In some implementations, the condition data may include data gathered from a variety of data sources, such as data sources gathering data from the utilities 116 and the appliances 118 and/or data from the property market database 132. By way of example and without limitation, such data sources may include Wi-Fi enabled thermostats, home automation system components (e.g., temperature sensors, humidity sensors, motion sensors, remote control electrical sockets, etc.), Wi-Fi enabled home security systems, cameras, smart utility meters, etc.

In some implementations, the condition data corresponding to the property may be immediately descriptive of property condition or descriptive of property condition after manipulation. For example, data indicating square footage, construction type, location, year of construction, etc. may be immediately descriptive of the condition of a property. On the other hand, smart meter readings, furnace intake or temperature measurements, kitchen appliance energy consumption, etc. are example types of data that may be descriptive of the condition of a property only after data manipulation. In one scenario, an analysis of energy consumption, water input/output, and temperature measurements of a kitchen appliance (e.g., dishwasher, refrigerator, etc.) in a certain property may indicate that the kitchen appliance is overused and does not operate efficiently. As such, an accurate assessment of the condition of the property will indicate that the kitchen appliance will likely need to be replaced and/or the kitchen appliances contributes negatively to utility payments.

The condition data, corresponding to the property identified in the property enrollment, may be updated or augmented with additional condition data gathered from the enrolled property, in an implementation. For example, the condition report server 102 may use existing condition data (i.e. existing at the time of the property enrollment, such as data from a property market database or previously gathered data by an insurance company) to make an initial assessment of property condition and then use additional condition data gathered over time to establish a property condition trend. The property condition trend may provide a property owner with early warning of potential maintenance issues, an accurate cost of ownership, property depreciation information, estimated energy/utility payments, etc. In some implementations, the additional condition data may be gathered from the same data sources as the data sources of the existing condition data and/or different data sources.

In some implementations, owners of properties may receive incentives for contributing condition data to be stored in a condition database. For example, insurance companies may offer discounts, coupons, or prizes to customers who contribute Wi-Fi enable thermostat data or smart meter data. In another example, an real estate company may offer discounted fees or commission to customers listing homes for which condition data is available.

Returning to FIG. 4, the condition data, retrieved from a property condition database, is analyzed to assess the condition of the property (block 306), in an implementation. For example, the condition report server 102 may analyze the condition data to assess the condition of the property in relation to quality and value (e.g. maintenance, longevity, cost of ownership, mechanical operation, aesthetic condition, market value, replacement costs, etc.)

In a simple example scenario, the condition report server 102 may retrieve water consumption data, thermostat data, energy consumption data, and furnace intake data from the condition database 115. The water comsumption data and energy consumption data may indicate that a property has average utility costs. However, the thermostat data and furnace intake data may indicate that the furnace on the property does not respond well to adjustments in temperature and has erratic air intake behavior. In such an example scenario, the condition report server 102 may assess the condition of the property as relatively low with respect to utility infrastructure quality/value because of probable current and/or future issues caused by the furance.

An owner considering only the water comsumption data and energy consumption data (e.g. kWh's, gallons, etc.) may overestimate the condition of the property, in the above scenario. In contrast, the techniques of the present disclosure are able to provide an accurate assessment of property condition by analyzing granular data gathered from the property over time, such as the thermostat data and furnace intake data in the above scenario, for example.

In some implementations, the condition report server 102 may collectively or comparatively analyze the condition data to assess property condition. For example, year of construction data may indicate a relatively old age of a septic system, whereas water flow data and septic system sensor data may indicate that the septic system is lightly used and maintained properly. Independently, the year of construction data may indicate low quality or value. However, when combined with the water flow data and septic system sensor data, from which one could infer proper maintenance and gentle use, the condition report server 102 may more moderately assess the property quality and value, in the example case.

The report server 102 may assess both the past and future condition of the property in addition to the current condition of the property, in some implementations. The report server 102 may use prediction, modeling, simulation, or other suitable algorithms to infer a condition of a property at times in the past and predict conditions of a property in the future, for example. A prediction algorithm (e.g. trained on reference data) may predict that a certain property will need appliance replacement in one year, plumbing work in two years, and roof replacement in one and a half years, in an example scenario. This information is valuable to a property owner in that the owner may appropriately plan for such events.

Also, the condition report server 102 may use prediction, modeling, etc. algorithms to accurately assess the current condition of a property, even when condition data is not available over the entire life, or age, of the property. For example, condition data may be available for only five out of ten years of the life of a property. In such a case, a simulation/modeling algorithm may stitch together the available data with simulations to provide an accurate assessment of current property condition.

Once the property condition is assessed, property condition descriptors reflecting the condition trend of the property are developed (block 308). The condition descriptors may include any suitable representation or representations of the condition trend of the property, in an implementation. The condition descriptors may include, by way of example: (i) scores or ratings representing relative quality, value, mechanical operation, etc., such as a score between one and one hundred or a rating of one to five stars; (ii) text statements reflecting a condition, such as “low,” “moderate,” or “high” cost of ownership, “this home may have major repair needs within two years,” etc.; (iii) graphical representations of condition information, such as graphs, plots, or charts indicating average utility costs as a function of time, maintenance/repair events per year, etc.; (iv) images or icons, such as a thumbs up/down, caution sign icons, etc.

Next, a property condition report is generated to be presented on an end user device (block 310). In some implementations, the property condition report includes some or all of the condition descriptors developed at block 308. For example, the condition report server 102 may generate a property condition report in the form of one or more web pages including at least some of the condition descriptors, where the web pages may be displayed via a web browser application executed on the one or more end user devices 106.

In some implementations, the property condition report is interactive. For example, the condition report server 102 may develop a property condition report in the form of one or more interactive web pages or in the form of content for an interactive property condition reporting application. An initial web page may display a general representation of property condition, such as a series of scores or ratings, and, upon customer selection of a score or rating, further or modified web pages may display more detailed information, such as graphs, tables, etc. or even portions of the raw condition data itself, for example.

Finally, the property condition report is sent to an end user device for presentation to the owner of the property (block 312). In some implementations, the condition report server 102 may initially send a partial property condition report to the end user device, and then, based on user interaction with the report, the condition report server 102 may send additional portions of the property condition report. Further, the condition report server 102 may generate and send variations of the property condition report based on end user device configurations, in an implementation. For example, the condition report server may generate one variation of a property condition report for a visually appealing display on a smartphone and another variation of a property condition report for a visually appealing display on a tablet, laptop, or desktop computer.

### Property Condition Reporting

FIG. 5 is a flow diagram of an example method 400 for reporting property condition information on an end user device. The method 440 may be implemented by the one or more end user devices 106, for example.

To begin, a property ownership tool is initiated (block 402). In one implementation, one of the end user devices 106 may execute a property ownership tool stored in memory (e.g. the property condition reporting tool 215), where the property ownership tool facilitates communications with the condition report server 102 and the display of property condition reports. In another implementation, a user of one of the end user devices 106 may initiate a property ownership tool via a web browser application.

Next, property identification information is received via a user interface (block 404), such as the user interface 240. In some implementations, one of the end user devices 106 may display a series of forms, questions, buttons, etc. to prompt a user of one of the end user devices 106 to enter property identification information. For example, one of the end user devices 106 may display a text box for entering an address and a “continue” button such that the user may enter the address via a keyboard or touchscreen and tap or click the continue button to confirm the identification information.

In another implementation, a user of an end user device may use sensors in the device itself to automatically generate property identification information. For example, a camera on a smartphone may capture an image of a street number or scan a bar code on integrated sensors or devices. In such a case, the end user device may analyze the automatically generated data and, in some implementations, transform the data into convenient formats (e.g. text, numbers, etc.) for property identification.

Once property identification information is received, a property enrollment is sent to a condition report server (block 406). The property enrollment includes the property identification information, and, in some implementations, the property enrollment includes device specific information. For example, the property enrollment may include device specific information indicating device configurations (e.g. hardware, software, etc.), device users (e.g. usernames, passwords, identification numbers, etc.), device locations, etc.

Returning to FIG. 5, a property condition report is received in response to the property condition query (block 408). For example, the condition report server 102 may electronically communicate the property condition report to one of the end user devices as web content for display in a property condition reporting tool or web browser. In addition, the condition report server 102 may send the property condition report via email, text message, or hyperlink, for example.

In some implementations, the condition report server 102 may use device specific information to customize property condition reports. For example, the condition report server may use a device location to generate a property condition report emphasizing relevant property condition descriptors (e.g. through prominent display, icons, bold text, etc.).

In one scenario, an end user device may be located in an area with severe winter weather, and, as such, the condition report server may generate a property condition report that emphasizes heating costs, insulation issues, repair issues, etc. that would be particularly relevant in cold climates. In another example, the condition report server 102 may customize property condition reports for individual device users. In one scenario, a device user may indicate (via a user interface) that maintenance issues are not as important as property aesthetic condition (e.g. paint condition, type of siding, etc.). As such, the condition report server 102 may display information regarding properties aesthetics predominately in a property condition report or analyze data related to aesthetics in more detail, for example.

In another scenario, the condition report server 102 may analyze condition data and predict that a property will need replacement appliances within a year. The condition report server 102 may also use the location of an end user device, associated with the property, to advertise or recommend nearby businesses offering appliance replacement services, in the example scenario. In some implementations, the condition report server 102 may communicate with third party servers, where the third party servers provide advertisements based on end user device location and property condition.

Upon receiving the property condition report, all or part of the property condition report is displayed (block 410). For example, one of the end user devices 106 may display interactive web pages or other interactive property condition content, as described with reference to FIG. 4. In some implementations, one of the end user devices 106 may download or view the property condition report as a document, such as a portable document format (PDF) document, Microsoft Excel® spreadsheet, or other suitable document. For example, one of the end user device 106 may save a property condition report document in computer-readable memory or print a property condition report document for later viewing. Also, a user may “share” part or all of a property condition report with friends, potential buyers, etc. via email, text message, hyperlink, Facebook®, etc., in some implementations

1. A computer-implemented method for reporting residential or commercial real estate property ownership information comprising:
receiving, via a computer network, an enrollment from a customer, wherein the enrollment includes information identifying a residential or commercial real property owned by the customer;
retrieving existing condition data corresponding to the residential or commercial real property from a condition database, wherein the existing condition data is descriptive of the operation of components of the residential or commercial real property at times prior to receiving the enrollment;
determining, by one or more processors, a first condition of the residential or commercial real property based on the operation of the components of the residential or commercial real property prior to receiving the enrollment as described in the existing condition data, wherein the first condition of the residential or commercial real property relates to one of a market value or replacement cost value of the residential or commercial real property and a quality level of the residential or commercial real property;
gathering, via the computer network, additional condition data corresponding to the residential or commercial real property,
wherein the additional condition data indicates the operation of the components of the residential or commercial real property after receiving the enrollment, and
wherein at least some of the additional condition data is generated, over a time period greater than a day, by a device inside the residential or commercial real property monitoring the operation of the components of the residential or commercial real property;
determining, by the one or more processors, a second condition of the residential or commercial real property based on the operation of the components of the residential or commercial real property after receiving the enrollment as indicated in the additional condition data, wherein the second condition relates to the one of the market value or the replacement cost value of the residential or commercial real property and the quality level of the residential or commercial real property;
generating, by the one or more processors, a property ownership report, wherein the property ownership report includes visual descriptors indicative of the first condition and the second condition; and
communicating, via the computer network, the property ownership report to a remote computing device for presentation to the customer.

2. The computer-implemented method of claim 1, wherein the information identifying the residential or commercial real property includes at least one of an address, zip code, phone number, builder name, year of construction, name of insurance company, identification number, construction type, owner name, owner contact information, real estate agent identification, or insurance policy number.

3. The computer-implemented method of claim 1, wherein at least one of the first condition or the second condition of the residential or commercial real property further includes a state of mechanical operation of the residential or commercial real property.

4. The computer implemented method of claim 3, wherein the additional condition data indicates at least one of current or prior geographic locations, energy consumption, measurements from appliance sensors, repair or maintenance to the residential or commercial real property, information from the title of the residential or commercial real property, usage of the residential or commercial real property, or preferences of the customer.

5. The computer-implemented method of claim 1, wherein the device inside the residential or commercial real property generated the existing condition data prior the receiving of the enrollment.

6. The computer-implemented method of claim 1, further comprising storing, by the one or more processors, the additional condition data in the condition database.

7. The computer-implemented method of claim 6, wherein the additional condition data is stored along with the existing condition data as a current condition data set.

8. The computer-implemented method of claim 6, wherein one or more timestamps are stored with the additional condition data identifying one or more particular times at which the additional condition data was gathered.

9. The computer-implemented method of claim 1, wherein analyzing, by the one or more processors, the existing condition data and the additional condition data to establish a property condition trend includes:
determining, by the one or more processors, the condition of the residential or commercial real property at a point in time for which the existing condition data or the additional condition data is available; and
predicting, by the one or more processors, at least one of (i) a current or future market value of the residential or commercial real property, or (ii) a current or future need for maintenance or repair to the residential or commercial real property.

10. (canceled)

11. The computer-implemented method of claim 1, wherein the visual descriptors include one of text, image, graph, plot, chart, or table based representations of the first condition and the second condition.

12. A computer-implemented method for reporting property condition information on a computing device including a display device and a user interface, the method comprising:
receiving, via the user interface, a property enrollment, wherein the property enrollment includes information identifying a residential or commercial real property;
generating, by one or more processors, a property condition query, wherein the property condition query includes the information identifying the residential or commercial real property;
sending, via a network interface at the computing device, the property condition query to a server;
receiving, via the network interface at the computing device, information indicative of a first condition and a second condition of the residential or commercial real property,
wherein each of the first condition and the second condition relates to one of a market value of the residential or commercial real property or a replacement cost value of the residential or commercial real property and a quality level of the residential or commercial real property, and
wherein the first condition of the residential or commercial real property is determined based on existing condition data generated before receiving the property enrollment,
wherein the second condition of the residential or commercial real property is determined based on additional condition data generated after receiving the property enrollment, and
wherein at least some of the additional condition data is generated, over a time period greater than a day, by a device inside the residential or commercial real property monitoring the operation of the components of the residential or commercial real property;
rendering, by the one or more processors, an image representing at least some of the information indicative of the first condition and the second condition; and
presenting, via the display device, the image representing the at least some of the information indicative of the first condition and the second condition.

13. The computer-implemented method of claim 12, wherein the information identifying the residential or commercial real property includes at least one of an address, zip code, phone number, builder name, year of construction, name of insurance company, identification number, construction type, owner name, owner contact information, real estate agent identification, or insurance policy number.

14. The computer-implemented method of claim 12, wherein at least one of the first condition or the second condition of the residential or commercial real property further includes a state of mechanical operation of the residential or commercial real property.

15. The computer implemented method of claim 14, wherein the additional condition data indicates at least one of current or prior geographic locations, energy consumption, measurements from appliance sensors, repair or maintenance to the residential or commercial real property, information from the title of the residential or commercial real property, usage of the residential or commercial real property, or preferences of the customer.

16. The computer-implemented method of claim 12, wherein the information indicative of the first condition and the second condition includes at least one of:
(i) a prediction of a current or future market value of the residential or commercial real property,
(ii) a prediction of a current or future need for maintenance or repair to the residential or commercial real property,
(iii) an indication of one or more recommended points in time to buy or sell the residential or commercial real property, or
(iv) a suggestion for improving the market value, the trade-in value, or the overall quality level of the residential or commercial real property.

17. A computer device for reporting property ownership information, the computer device comprising:
one or more processors; and
one or more non-transitory memories coupled to the one or more processors;
wherein the one or more memories include computer executable instructions stored therein that, when executed by the one or more processors, cause the one or more processors to:
receive, via a computer network, an enrollment from a customer, wherein the enrollment includes information identifying a residential or commercial real property owned by the customer;
retrieve existing condition data corresponding to the residential or commercial real property from a condition database, wherein the existing condition data is descriptive of the operation of components of the residential or commercial real property at times prior to receiving the enrollment;
determine a first condition of the residential or commercial real property based on the operation of the components of the residential or commercial real property prior to receiving the enrollment as described in the existing condition data, wherein the first condition of the residential or commercial real property relates to one of a market value or replacement cost value of the residential or commercial real property and a quality level of the residential or commercial real property;
gather, via the computer network, additional condition data corresponding to the residential or commercial real property,
wherein the additional condition data indicates the operation of the components of the residential or commercial real property after receiving the enrollment, and
wherein at least some of the additional condition data is generated, over a time period greater than a day, by a device inside the residential or commercial real property monitoring the operation of the components of the residential or commercial real property;
determine a second condition of the residential or commercial real property based on the operation of the components of the residential or commercial real property after receiving the enrollment as indicated in the additional condition data, wherein the second condition relates to the one of the market value or the replacement cost value of the residential or commercial real property and the quality level of the residential or commercial real property;
generate a property ownership report, wherein the property ownership report includes visual descriptors indicative of the first condition and the second condition; and
communicate, via the computer network, the property ownership report to a remote computing device for presentation to the customer.

18. The computer device of claim 17, wherein each of the first condition and the second condition of the residential or commercial real property further includes a state of mechanical operation of the residential or commercial real property.

19. The computer device of claim 17, wherein the computer executable instruction further cause the one or more processors to store the additional condition data in a database.

20. The computer device of claim 18, wherein the database storing the additional condition data is separate from the condition database storing the existing condition data.
